(19) United States
(12) Patent Application Publication
(10) Pub. No.: US 2016/0252853 A1
(43) Pub. Date: Sep. 1, 2016

(54) FIXING MEMBER, FIXING DEVICE, AND IMAGE-FORMING APPARATUS

(71) Applicant: FUJI XEROX CO., LTD., Tokyo (JP)

(72) Inventor: Takanori SUGA, Kanagawa (JP)

(73) Assignee: FUJI XEROX CO., LTD., Tokyo (JP)

(21) Appl. No.: 14/829,853

(22) Filed: Aug. 19, 2015

(30) Foreign Application Priority Data
Feb. 26, 2015 (JP) 2015-036312

(51) Int. Cl. G03G 15/20

(52) U.S. Cl. CPC G03G 15/206

(57) ABSTRACT

A fixing member includes a substantially cylindrical substrate, an elastic layer disposed around the substrate and having a surface irradiated with UV radiation, a surface layer covering the surface of the elastic layer, and an adhesive layer disposed between the elastic layer and the surface layer. The adhesive layer contains a glycidoxy-containing silane coupling agent.

### CROSS-REFERENCE TO RELATED APPLICATIONS

This application is based on and claims priority under 35 USC 119 from Japanese Patent Application No. 2015-036312 filed Feb. 26, 2015.

### BACKGROUND

(i) Technical Field

The present invention relates to fixing members, fixing devices, and image-forming apparatuses.

(ii) Related Art

Electrophotographic image-forming apparatuses such as copiers and printers include a fixing device that fixes an unfixed toner image to a recording medium such as recording paper to form an image thereon. Examples of fixing devices for image-forming apparatuses include roller-to-roller fixing devices and belt nip fixing devices. A roller-to-roller fixing device includes a fixing roller for heating as a fixing member and a pressing roller as a pressing member. Belt nip fixing is a technology that supports, for example, faster operation of image-forming apparatuses. A belt nip fixing device includes a rotatable fixing roller whose surface is elastically deformable as a fixing member, a belt member movable in contact with the fixing roller, and a nonrotatable pressure pad disposed inside the belt member as a pressing member. The pressure pad presses the belt member against the fixing roller to form a contact area therebetween. A recording medium passes through the nip between the belt member and the fixing roller.

Elastic rollers are used as fixing rollers in fixing devices, particularly for color applications. Elastic rollers are typically made of silicone rubbers, which are heat-resistant. Recently, there have been proposed many fixing rollers including an elastic roller covered with a fluoropolymer tube serving as a toner release layer to improve compatibility with oil-free toners, which contain waxes, unlike conventional toners containing oils for assistance in toner release.

Examples of methods for covering an elastic roller with a fluoropolymer tube include a method involving forming an elastic layer containing a rubber material using a mold by one-piece molding with a fluoropolymer tube formed in advance and a method involving covering an elastic roller with a fluoropolymer tube in a later step. Another method for covering an elastic roller with a fluoropolymer involves coating an elastic layer with a fluoropolymer dispersion by a process such as spray coating or dip coating and then baking the coating. Tubes are often used, for example, for reasons of wear resistance.

### SUMMARY

According to an aspect of the invention, there is provided a fixing member including a cylindrical or substantially cylindrical substrate, an elastic layer disposed around the substrate and having a surface irradiated with UV radiation, a surface layer covering the surface of the elastic layer, and an adhesive layer disposed between the elastic layer and the surface layer. The adhesive layer contains a glycidoxy-containing silane coupling agent.

### BRIEF DESCRIPTION OF THE DRAWINGS

Exemplary embodiments of the present invention will be described in detail based on the following figures, wherein:

FIG. 1 is a schematic view of an example fixing device according to an exemplary embodiment of the present invention; and

FIG. 2 is a schematic view of an example image-forming apparatus according to an exemplary embodiment of the present invention.

### DETAILED DESCRIPTION

Exemplary embodiments of the present invention will now be described. These exemplary embodiments are given only by way of example and are not intended to limit the scope of the present invention.

### Fixing Device and Fixing Member

An example fixing device according to an exemplary embodiment will now be described. The fixing device according to this exemplary embodiment includes, for example, a rotatable fixing member, a belt member movable in contact with the fixing member, and a nip-forming member disposed opposite the fixing member with the belt member therebetween. The nip-forming member presses the belt member against the fixing member to form a nip through which a recording medium passes between the fixing member and the belt member. The fixing device may include a sliding sheet member extending from upstream in the passage direction of the recording medium between the nip-forming member and the belt member.

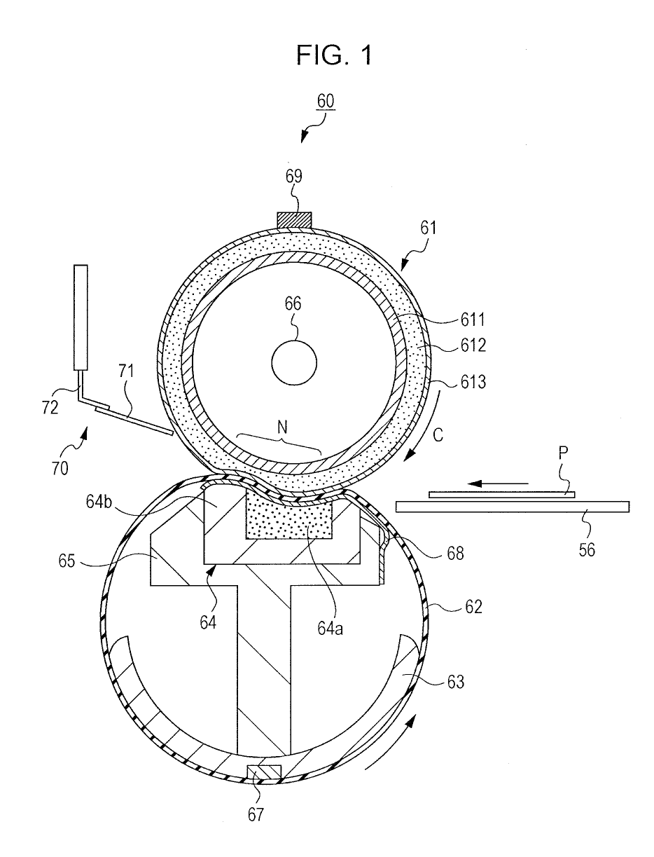

FIG. 1 is a schematic side sectional view of an example fixing device 60 according to this exemplary embodiment. The fixing device 60 shown in FIG. 1 includes a fixing roller 61 as an example fixing member, a pressing belt 62 movable in contact with the fixing roller 61 as an example belt member, a pressing pad 64 disposed opposite the fixing roller 61 with the pressing belt 62 therebetween as an example nip-forming member, and a sliding sheet member 68 extending from upstream in the passage direction of a recording medium 56 between the pressing pad 64 and the pressing belt 62. The pressing pad 64 presses the pressing belt 62 against the fixing roller 61 to form a nip through which the recording medium 56 passes between the fixing roller 61 and the pressing belt 62.

The fixing device 60 shown in FIG. 1 includes no support roller or pressing roller for belt tensioning. The pressing belt 62 is guided by a belt movement guide 63, described later, and is moved by the driving force of the fixing roller 61. This type of belt fixing device is sometimes called “free-belt fixing device” to distinguish it from those including support rollers and pressing rollers.

The fixing roller 61 is a cylindrical or substantially cylindrical roller including a substrate (cylindrical or substantially cylindrical substrate) 611 such as a metal substrate, an elastic layer 612 disposed around the substrate 611, and a surface layer 613 disposed over the elastic layer 612. The fixing roller 61 is rotatably supported. The fixing roller 61 will be described in detail later.

A heat source, for example, a heater such as a heater lamp 66, is disposed inside the fixing roller 61. A release member 70 that releases the recording medium 56 after fixing and a temperature sensor 69 used to control the surface temperature of the fixing roller 61 are also disposed around the fixing roller 61. The release member 70 includes a release baffle 71 extending adjacent to the fixing roller 61 in the direction opposite to the rotational direction C of the fixing roller 61 (i.e., in the counter direction) and a holder 72 holding the release baffle 71.

The pressing belt 62 is rotatably supported from inside by the pressing pad 64 and the belt movement guide 63. The pressing belt 62 may be an endless belt having no seams, i.e., an originally cylindrical belt, so that output images have no defects due to seams. The pressing belt 62, however, is not necessarily a seamless belt, but may be a seamed belt.

The pressing pad 64 is supported by a holder 65 such as a metal holder inside the pressing belt 62. The pressing pad 64 is disposed opposite the fixing roller 61 with the pressing belt 62 therebetween. The pressing pad 64 presses the pressing belt 62 against the fixing roller 61 to form a nip N through which the recording medium 56 passes between the fixing roller 61 and the pressing belt 62. The pressing pad 64 includes two pressing parts of different hardnesses, i.e., a prenip member 64a and a release nip member 64b, that are arranged in the passage direction of the recording medium 56. For example, the prenip member 64a, which is located on the medium entry side (i.e., upstream), is a rubber elastic member, whereas the release nip member 64b, which is located on the medium exit side (i.e., downstream), is a hard pressure-applying member such as a metal member. The pressure in the nip N is higher on the medium exit side than on the medium entry side. This may, for example, facilitate the release of the recording medium 56. The prenip member 64a and the release nip member 64b are supported by the holder 65 and press the pressing belt 62 against the fixing roller 61 from inside with the sliding sheet member 68 therebetween. The sliding sheet member 68 includes a low-friction layer such as a glass fiber sheet or fluoropolymer sheet (e.g., Teflon®).

The holder 65 includes a lubricant-applying member 67 extending in the longitudinal direction of the fixing device 60. The lubricant-applying member 67 is disposed in contact with the inner surface of the pressing belt 62 and supplies a lubricant such as an amino-modified silicone oil. The lubricant-applying member 67 supplies the lubricant to the sliding area between the pressing belt 62 and the sliding sheet member 68. This may reduce the sliding resistance between the pressing belt 62 and the pressing pad 64 with the sliding sheet member 68 therebetween.

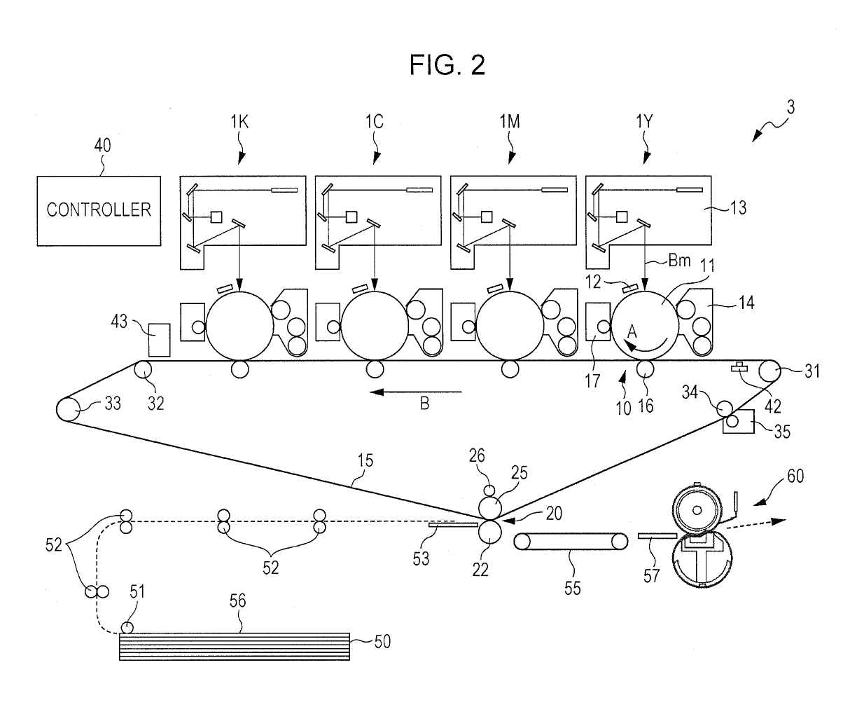

In the fixing device 60 shown in FIG. 1, the fixing roller 61 is coupled to a drive motor (not shown) and is rotated in the direction indicated by arrow C. As the fixing roller 61 is rotated, the pressing belt 62 is rotated in the same direction. After a second transfer section 20 of an image-forming apparatus shown in FIG. 2, described later, electrostatically transfers a toner image to the recording medium 56, a transport unit (not shown) transports the recording medium 56 to the nip N between the fixing roller 61 and the pressing belt 62 shown in FIG. 1. When the recording medium 56 passes through the nip N, an unfixed toner image P is fixed to the recording medium 56, for example, with the pressure in the nip N and the heat supplied from the fixing roller 61. After fixing, the recording medium 56 that has passed through the nip N is released from the fixing roller 61 by the release member 70 and leaves the fixing device 60. The fixing process is complete.

The sliding sheet member 68 extends from upstream in the passage direction of the recording medium 56 between the pressing pad 64 and the pressing belt 62. The sliding sheet member 68 may extend over the entire area between the pressing pad 64 and the pressing belt 62, for example, to reduce the sliding resistance between the pressing belt 62 and the pressing pad 64 with the sliding sheet member 68 therebetween. At least a portion of the sliding sheet member 68 upstream of the nip N is fixed to the holder 65, for example, with any fastener (not shown). Although the portion of the sliding sheet member 68 upstream of the nip N is fixed to the holder 65 in the example shown in FIG. 1, the sliding sheet member 68 is not necessarily fixed to the holder 65, but may be fixed to any other member that is disposed upstream of the nip N and that has an area sufficient for the sliding sheet member 68 to be fixed thereto. The downstream end of the sliding sheet member 68 in the passage direction of the recording medium 56 may be a free end without being fixed to any member, for example, to reduce strain in the sliding sheet member 68. The sliding sheet member 68 may, for example, reduce the sliding resistance between the pressing belt 62 and the pressing pad 64 with the sliding sheet member 68 therebetween during the rotation of the pressing belt 62.

The prenip member 64a of the pressing pad 64 is made of, for example, an elastomer such as silicone rubber or fluoroelastomer or a leaf spring. The release nip member 64b of the pressing pad 64 is made of, for example, a heat-resistant resin such as polyphenylene sulfide (PPS), polyimide, polyester, or polyamide or a metal such as iron, aluminum, or stainless steel.

The sliding sheet member 68 may be made of, for example, a fluoropolymer for reasons of wear resistance and lubricant retention. Examples of sliding sheet members made of fluoropolymers include fluoropolymer sheets, fluoropolymer coatings formed on substrates such as glass fabrics, and fluoropolymer sheets laminated on substrates such as glass fabrics. Examples of fluoropolymers include polytetrafluoroethylene (PTFE) resins, chlorotrifluoroethylene resins, hexafluoropropylene resins, vinyl fluoride resins, vinylidene fluoride resins, dichlorodifluoroethylene resins, and copolymers thereof. For example, PTFE resins may be used for reasons of wear resistance.

Examples of lubricants include silicone oils containing fluorinated lubricating oils, such as X-22-9446 oil (dynamic viscosity: 240 to 330 mm²/s (JIS Z 8803)) available from Shin-Etsu Chemical Co., Ltd.

The fixing roller 61, which serves as a fixing member in the fixing device 60 according to this exemplary embodiment, includes the cylindrical or substantially cylindrical substrate 611, the elastic layer 612 disposed around the substrate 611, the surface layer 613 covering the surface of the elastic layer 612, and an adhesive layer disposed between the elastic layer 612 and the surface layer 613. The surface of the elastic layer 612 is irradiated with UV radiation. The adhesive layer contains a glycidoxy-containing silane coupling agent.

In a heat aging test that simulates the environment in an image-forming apparatus, a fixing roller including an elastic layer formed by one-piece molding with a surface layer may exhibit cohesive failure in the elastic layer, whereas a fixing roller including an elastic layer covered with a tube in a later step may exhibit separation between the elastic layer and the adhesive layer. The fixing roller according to this exemplary embodiment is typically manufactured by forming and vulcanizing an elastic layer and covering the elastic layer with a surface layer in a later step. To inhibit separation between the elastic layer and the adhesive layer, the inventor has invented the following method. The inventor has discovered that a fixing roller including an elastic layer formed around a substrate and irradiated with UV radiation at a wavelength of, for example, 184.9 nm, and an adhesive layer covering the elastic layer and containing a glycidoxy-containing silane coupling agent may be more resistant to separation between the elastic layer and the adhesive layer than a fixing roller including an adhesive layer containing no glycidoxy-containing silane coupling agent. The use of a fixing roller with improved heat resistance that is resistant to separation between the elastic layer and the adhesive layer may provide good and stable image quality with few or no color spots. Color spots are believed to occur as follows. When separation occurs between the elastic layer and the adhesive layer, the pressing force in the separated area varies, and accordingly, the pressing force in the nip N becomes uneven. This results in poor fixing of part or all of a toner image to a recording medium and thus results in color spots.

UV irradiation provides good adhesion between the elastic layer and the adhesive layer. One possible explanation is as follows. UV irradiation modifies the rubber surface of the elastic layer to form active groups. When the glycidoxy-containing silane coupling agent is hydrolyzed into a silanol, the glycidoxy groups and the silanol in the adhesive layer react with the active groups on the modified rubber surface to promote adhesion.

The UV radiation used for UV irradiation has a wavelength of 100 to 400 nm. Preferably, but not necessarily, the UV radiation has a wavelength of 184.9 nm, which is a typical wavelength.

UV irradiation may be performed, for example, at a dose of 200 to 5,000 mJ/cm² in about 1 to about 10 minutes.

Examples of glycidoxy-containing silane coupling agents include glycidoxyalkyltrialkoxysilanes, glycidoxyalkyldialkoxysilanes, and glycidoxyalkylalkoxysilanes, including glycidoxypropyltrimethoxysilane, glycidoxypropyltriethoxysilane, glycidoxypropylmethyldimethoxysilane, and glycidoxypropylmethyldiethoxysilane. For reasons of reactivity, it is preferable to use glycidoxyalkyltrialkoxysilanes, more preferably glycidoxyalkyltrialkoxysilanes in which the alkyl group has 1 to 5 carbon atoms and the alkoxy groups have 1 to 3 carbon atoms, even more preferably a glycidoxyalkyltrialkoxysilane in which the alkyl group has 3 carbon atoms and the alkoxy groups have 1 carbon atom, i.e., glycidoxypropyltrimethoxysilane.

The glycidoxy-containing silane coupling agent is preferably present in the adhesive layer in an amount of 5% to 30% by mass or about 5% to about 30% by mass, more preferably 5% to 20% by mass or about 5% to about 20% by mass, of the total mass of the adhesive layer. If the glycidoxy-containing silane coupling agent is present in the adhesive layer in an amount of less than 5% by mass, it may have insufficient adhesion. If the glycidoxy-containing silane coupling agent is present in the adhesive layer in an amount of more than 30% by mass, the silane coupling agent may gel during manufacture.

The adhesive layer has a thickness of, for example, 3 to 100 μm. If the adhesive layer has a thickness of less than 3 μm, it may have insufficient adhesion. If the adhesive layer has a thickness of more than 100 μm, it may collapse.

The substrate 611 of the fixing roller 61 is made of, for example, a metal or alloy with high thermal conductivity, such as iron, aluminum (e.g., A-5052), stainless steel, or copper. The substrate 611 may also be made of a ceramic or a fiber-reinforced metal (FRM).

The substrate 611 typically has an outer diameter of, for example, 10 to 50 mm. If the substrate 611 is made of aluminum, it may have a thickness of about 0.5 to about 4 mm. If the substrate 611 is made of stainless steel or iron, it may have a thickness of about 0.1 to about 2 mm.

Examples of materials for the elastic layer 612 of the fixing roller 61 include silicone rubbers and fluoroelastomers. Examples of silicone rubbers include RTV silicone rubbers and HTV silicone rubbers. Specific examples include polydimethylsilicone rubber (MQ), methylvinylsilicone rubber (VMQ), methylphenylsilicone rubber (PMQ), and fluorosilicone rubber (FVMQ). The elastic layer 612 may be formed either by one-piece molding or by flow coating, provided that the desired shape can be achieved.

The elastic layer 612 has a thickness of, for example, 0.2 to 3 mm, preferably 0.3 to 1 mm.

The surface layer 613 of the fixing roller 61 is made of, for example, a fluoropolymer. Examples of fluoropolymers include PTFE and tetrafluoroethylene-perfluoroalkyl vinyl ether copolymers (PFA) such as tetrafluoroethylene-perfluoromethyl vinyl ether copolymer (MFA), tetrafluoroethylene-perfluoroethyl vinyl ether copolymer (EFA), and tetrafluoroethylene-perfluoropropyl vinyl ether copolymer.

The surface layer 613 has a thickness of, for example, 5 to 100 μm, preferably 10 to 40 μm.

The fixing roller 61 may be manufactured, for example, by the following method. An adhesive composition containing a glycidoxy-containing silane coupling agent and other optional additives in predetermined amounts is prepared. An elastic layer composition is applied to a predetermined thickness on the outer surface of a cylindrical core coated with a primer in advance and is baked, for example, at 140° C. to 250° C. for 30 minutes to 3 hours to obtain an elastic layer. After the elastic layer is allowed to cool to room temperature, the surface of the elastic layer is irradiated with UV radiation at a wavelength of, for example, 184.9 nm. The adhesive composition is applied to a thickness of, for example, 3 to 100 μm on the elastic layer. A fluoropolymer tube such as a PFA tube, serving as a surface layer, is attracted to the inner surface of a cylindrical mold under reduced pressure. The elastic layer coated with the adhesive composition is then inserted into the mold. After the insertion is complete, the reduced pressure is removed to cover the elastic layer with the fluoropolymer tube. A fixing roller is thus obtained.

Although the fixing device 60 according to this exemplary embodiment is a roller-to-belt fixing device including the fixing roller according to this exemplary embodiment as a fixing member and a pressing belt as a pressing member, other configurations are possible. One alternative configuration is a roller-to-roller fixing device including the fixing roller according to this exemplary embodiment as a fixing member and a pressing roller as a pressing member.

### Image-Forming Apparatus

An image-forming apparatus according to an exemplary embodiment may have any configuration including the fixing member according to the above exemplary embodiment. The image-forming apparatus includes, for example, an image carrier having a surface; a charging unit that charges the surface of the image carrier; a latent-image forming unit that forms an electrostatic latent image on the surface of the image carrier; a developing unit that develops the electrostatic latent image formed on the surface of the image carrier with a developer to form a toner image; a transfer unit that transfers the toner image to a transfer medium; and a fixing device that fixes the toner image to the transfer medium. The fixing device includes the fixing member according to the above exemplary embodiment. The image-forming apparatus according to this exemplary embodiment may optionally include an image-carrier cleaning unit that cleans the surface of the image carrier by removing residual toner and other debris from the surface of the image carrier after transfer.

The image-forming apparatus according to this exemplary embodiment will now be described with reference to the drawings, although the following exemplary embodiment is not intended to limit the scope of the present invention.

FIG. 2 is a schematic view of an example image-forming apparatus according to this exemplary embodiment. An image-forming apparatus 3 shown in FIG. 2 includes multiple electrophotographic image-forming units 1Y, 1M, 1C, and 1K that form toner images of different colors; first transfer units 10 that sequentially transfer (first transfer) the toner images of different colors from the image-forming units 1Y, 1M, 1C, and 1K to an intermediate transfer belt 15; a second transfer unit 20 that simultaneously transfers (second transfer) the superimposed toner images from the intermediate transfer belt 15 to a recording medium (recording paper) 56; and a fixing device 60 that fixes the transferred images to the recording medium 56. The image-forming apparatus 3 further includes a controller 40 that controls the operation of each device (each unit).

In this exemplary embodiment, the image-forming units 1Y, 1M, 1C, and 1K each include a photoreceptor drum 11 that rotates in the direction indicated by arrow A and electrophotographic devices disposed around the photoreceptor drum 11. The electrophotographic devices include, in sequence, a charging device 12 that charges the photoreceptor drum 11, a laser exposure device 13 (an exposure beam is indicated by reference character Bm in FIG. 2) that writes an electrostatic latent image on the photoreceptor drum 11, a developing device 14 that contains a toner of any color and that develops the electrostatic latent image on the photoreceptor drum 11 with the toner, a first transfer roller 16 that transfers the toner image from the photoreceptor drum 11 to the intermediate transfer belt 15 in the first transfer unit 10, and a drum cleaner 17 that removes residual toner from the photoreceptor drum 11. These image-forming units 1Y, 1M, 1C, and 1K are arranged substantially in a straight line in the following order from upstream: yellow (Y), magenta (M), cyan (C), and black (K).

The intermediate transfer belt 15, serving as an intermediate transfer member, is an endless belt made of a film of resin such as polyimide or polyamide containing an appropriate amount of antistatic agent such as carbon black. The intermediate transfer belt 15 has a volume resistivity of, for example, 10⁶ to 10¹⁴ Ω·cm and a thickness of, for example, about 0.1 mm. The intermediate transfer belt 15 is circulated (rotated) at a predetermined speed in the direction indicated by arrow B in FIG. 1 by various rollers. In this exemplary embodiment, the various rollers include a drive roller 31 that rotates the intermediate transfer belt 15 as the drive roller 31 is driven, for example, by a motor (not shown) capable of operating at constant speed; a support roller 32 that supports the intermediate transfer belt 15, which extends in the direction in which the photoreceptor drums 11 are arranged; a tension roller 33 that tensions the intermediate transfer belt 15 and also functions as a compensating roller to prevent, for example, meandering of the intermediate transfer belt 15; a backup roller 25 disposed in the second transfer unit 20; and a cleaning backup roller 34 disposed in a cleaning unit that scrapes residual toner from the intermediate transfer belt 15.

Each first transfer unit 10 includes the first transfer roller 16, which is disposed opposite the photoreceptor drum 11 with the intermediate transfer belt 15 therebetween. The first transfer roller 16 includes, for example, a shaft (not shown) and a sponge layer (not shown) fixed around the shaft and serving as an elastic layer. The shaft is, for example, a cylindrical rod made of a metal such as iron or stainless steel. The sponge layer is, for example, a cylindrical sponge roller made of a blend of acrylonitrile-butadiene rubber (NBR), styrene-butadiene rubber (SBR), and ethylene-propylene-diene rubber (EPDM) and containing a conductor such as carbon black. The sponge layer has a volume resistivity of, for example, 10⁷ to 10⁹ Ω·cm. The first transfer rollers 16 are pressed against the photoreceptor drums 11 with the intermediate transfer belt 15 therebetween. A voltage (first transfer bias) of opposite polarity to the toner (negative, which applies hereinafter) is applied to the first transfer rollers 16. This causes the toner images on the photoreceptor drums 11 to be sequentially electrostatically attracted to the intermediate transfer belt 15 such that they are superimposed on top of each other.

The second transfer unit 20 includes a second transfer roller 22 disposed on the toner-image carrying side of the intermediate transfer belt 15 and the backup roller 25. The backup roller 25 includes, for example, a surface layer made of a tube of a blend of EPDM and NBR in which carbon is dispersed and an inner layer made of EPDM. The backup roller 25 has a surface resistivity of, for example, 10⁷ to 10¹⁰ Ω/square and a hardness of, for example, 70° (ASKER durometer Type C, Kobunshi Keiki Co., Ltd., which applies hereinafter). The backup roller 25 is disposed on the back surface of the intermediate transfer belt 15 and serves as a counter electrode for the second transfer roller 22. A power supply roller 26, such as a metal roller, that applies a second transfer bias is disposed in contact with the backup roller 25.

The second transfer roller 22 includes, for example, a shaft (not shown) and a sponge layer (not shown) fixed around the shaft and serving as an elastic layer. The shaft is, for example, a cylindrical rod made of a metal such as iron or stainless steel. The sponge layer is, for example, a cylindrical sponge roller made of a blend of NBR, SBR, and EPDM and containing a conductor such as carbon black. The sponge layer has a volume resistivity of, for example, 10⁷ to 10⁹ Ω·cm. The second transfer roller 22 is pressed against the backup roller 25 with the intermediate transfer belt 15 therebetween. The second transfer roller 22 is grounded. A second transfer bias is formed between the second transfer roller 22 and the backup roller 25 to transfer the toner images to the recording medium 56 transported to the second transfer unit 20.

An intermediate transfer belt cleaner 35 is disposed downstream of the second transfer unit 20 along the intermediate transfer belt 15 so as to be movable into and out of contact with the intermediate transfer belt 15. The intermediate transfer belt cleaner 35 cleans the surface of the intermediate transfer belt 15 by removing residual toner and other debris such as paper powder from the intermediate transfer belt 15 after second transfer. In this exemplary embodiment, a reference sensor (home position sensor) 42 is disposed upstream of the yellow image-forming unit 1Y. The reference sensor 42 generates a reference signal for providing an appropriate timing for image formation to the image-forming units 1Y, 1M, 1C, and 1K. An image density sensor 43 for image quality control is disposed downstream of the black image-forming unit 1K. The reference sensor 42 detects a mark on the back surface of the intermediate transfer belt 15 and generates a reference signal. Upon receiving the reference signal, the controller 40 sends a command to start image formation to the image-forming units 1Y, 1M, 1C, and 1K.

The image-forming apparatus 3 according to this exemplary embodiment further includes a paper transport system. The paper transport system includes, for example, a paper tray 50 containing a stack of recording media 56, a pickup roller 51 that feeds a recording medium 56 from the paper tray 50, transport rollers 52 that transport the recording medium 56 fed by the pickup roller 51, a transport chute 53 that transports the recording medium 56 transported by the transport rollers 52 to the second transfer unit 20, a transport belt 55 that transports the recording medium 56 to the fixing device 60 after second transfer by the second transfer roller 22, and a fixing entry guide 57 that guides the recording medium 56 to the fixing device 60.

The basic image-forming process of the image-forming apparatus 3 according to this exemplary embodiment will now be described. In the image-forming apparatus 3 shown in FIG. 2, the image-forming units 1Y, 1M, 1C, and 1K execute an image-forming procedure after an image processing system (IPS) (not shown) processes image data received from a device such as an image input terminal (IIT) (not shown) or a personal computer (PC) (not shown). Specifically, the IPS executes predetermined image processing operations on the received reflectance data, including, for example, shading correction, misalignment correction, brightness/color space conversion, gamma correction, and various image editing operations such as frame deletion, color editing, and position editing. The processed image data is converted into colorant gradation data for four colors, i.e., Y, M, C, and K, and is fed to the laser exposure devices 13.

Based on the received colorant gradation data, the laser exposure devices 13 of the image-forming units 1Y, 1M, 1C, and 1K irradiate the photoreceptor drums 11 with exposure beams Bm emitted from, for example, semiconductor lasers. After the charging devices 12 of the image-forming units 1Y, 1M, 1C, and 1K charge the surfaces of the photoreceptor drums 11, the laser exposure devices 13 expose the surfaces of the photoreceptor drums 11 to the exposure beams Bm while scanning the exposure beams Bm thereover to form electrostatic latent images. The image-forming units 1Y, 1M, 1C, and 1K then develop the resulting electrostatic latent images into Y, M, C, and K toner images.

The toner images are transferred from the photoreceptor drums 11 of the image-forming units 1Y, 1M, 1C, and 1K to the intermediate transfer belt 15 in the first transfer units 10, where the photoreceptor drums 11 are in contact with the intermediate transfer belt 15. More specifically, in the first transfer units 10, the first transfer rollers 16 apply a voltage (first transfer bias) of opposite polarity to the toner (negative) to the substrate of the intermediate transfer belt 15 to sequentially transfer the toner images to the surface of the intermediate transfer belt 15 such that they are superimposed on top of each other.

After the toner images are sequentially transferred to the surface of the intermediate transfer belt 15, the toner images are transported to the second transfer unit 20 by the movement of the intermediate transfer belt 15. When the toner images are transported to the second transfer unit 20, the pickup roller 51 in the paper transport system rotates and feeds a recording medium 56, i.e., a sheet of paper of predetermined size, from the paper tray 50 in sync with the transportation of the toner images to the second transfer unit 20. The recording medium 56 fed by the pickup roller 51 is transported through the transport chute 53 to the second transfer unit 20 by the transport rollers 52. Before reaching the second transfer unit 20, the recording medium 56 is temporarily stopped and is brought into registration with the toner images on the intermediate transfer belt 15 as a registration roller (not shown) rotates in sync with the movement of the intermediate transfer belt 15.

In the second transfer unit 20, the second transfer roller 22 is pressed against the backup roller 25 with the intermediate transfer belt 15 therebetween. The recording medium 56 transported in sync enters the nip between the intermediate transfer belt 15 and the second transfer roller 22. The power supply roller 26 then applies a voltage (second transfer bias) of the same polarity as the toner (negative) to create a transfer field between the second transfer roller 22 and the backup roller 25. In the second transfer unit 20, where the second transfer roller 22 is pressed against the backup roller 25, the unfixed toner images are simultaneously electrostatically transferred from the intermediate transfer belt 15 to the recording medium 56.

The recording medium 56 having the toner images thereon is released from the intermediate transfer belt 15 and is transported by the second transfer roller 22 to the transport belt 55 disposed downstream of the second transfer roller 22 in the paper transport direction. The transport belt 55 transports the recording medium 56 to the fixing device 60 at a transport speed suitable for the fixing device 60.

When the recording medium 56 is transported to the fixing device 60, as described above, the unfixed toner images are fixed to the recording medium 56 with heat and pressure by the fixing device 60. The recording medium 56 having the fixed images thereon is transported to a paper output tray disposed in an output section of the image-forming apparatus 3.

After the transfer of the toner images to the recording medium 56 is complete, residual toner and other debris on the intermediate transfer belt 15 are transported to the cleaning unit by the rotation of the intermediate transfer belt 15 and is removed from the intermediate transfer belt 15 by the cleaning backup roller 34 and the intermediate transfer belt cleaner 35.

Although exemplary embodiments of the present invention have been described, these exemplary embodiments should not be construed as limiting the scope of the present invention. It should be understood that various changes, modifications, and improvements are possible within the scope of the present invention.

### EXAMPLE

The present invention is further illustrated by the following Examples and Comparative Examples, although these examples are not intended to limit the scope of the present invention.

### Example 1

### Preparation of Silicone Rubber Composition

One hundred parts by mass of a dimethylpolyorganosiloxane (vinyl content: 0.08 mmol/g, viscosity (25° C.): 30,000 Pa·s) is provided, and 40 parts by mass of the dimethylpolyorganosiloxane is placed in a mixer in advance. To the mixer is added 100 parts by mass of fine alumina powder (sodium ion content: 10 ppm, volume average particle size: 3 μm). The mixture is mixed with heating at 150° C. for 2 hours and is diluted with the remaining 60 parts by mass of the dimethylpolyorganosiloxane. The mixture is homogeneously mixed with 4.0 parts by mass of a dimethylsiloxane-methyl hydrogen siloxane copolymer blocked at both ends with trimethylsiloxy groups (content of hydrogen atoms linked to silicon atoms: 3 mmol/g, viscosity (25° C.): 5 mPa·s), 10 ppm (in platinum content) of chloroplatinic acid-divinyltetramethyldisiloxane complex, serving as a catalyst, 0.1 part by mass of 1-ethynyl-1-cyclohexanol, serving as a hardening retarder, and 2 parts by mass of ferric oxide (Fe₃O₄) to obtain a silicone rubber composition.

### Formation of Elastic Layer

An elastic layer is formed using the resulting silicone rubber composition. The silicone rubber composition is dropped onto the top of a cylindrical core (material: aluminum) coated with a primer (DY39-051 A/B, Dow Corning Toray Co., Ltd.) in advance while the cylindrical core is being rotated in a horizontal position. The silicone rubber composition is brought into contact with a blade placed at the bottom of the cylindrical core to form a coating having a predetermined thickness (600 μm). The resulting coating is baked at 200° C./hr. After the baking is complete, the coating is allowed to cool to room temperature. The surface of the coating is irradiated with UV radiation at a wavelength of 184.9 nm for 5 minutes (dose: 400 mJ/cm²) to obtain an elastic layer.

### Preparation of Adhesive Composition

One hundred parts by mass of a dimethylpolyorganosiloxane (vinyl content: 0.08 mmol/g, viscosity (25° C.): 30,000 Pa·s) is provided, and 40 parts by mass of the dimethylpolyorganosiloxane is placed in a mixer. To the mixer is added 100 parts by mass of fine alumina powder (sodium ion content: 10 ppm, volume average particle size: 3 μm). The mixture is mixed with heating at 150° C. for 2 hours and is diluted with the remaining 60 parts by mass of the dimethylpolyorganosiloxane. The mixture is homogeneously mixed with 4.0 parts by mass of a dimethylsiloxane-methyl hydrogen siloxane copolymer blocked at both ends with trimethylsiloxy groups (content of hydrogen atoms linked to silicon atoms: 3 mmol/g, viscosity (25° C.): 5 mPa·s), 10 ppm (in platinum content) of chloroplatinic acid-divinyltetramethyldisiloxane complex, serving as a catalyst, 0.1 part by mass of 1-ethynyl-1-cyclohexanol, serving as a hardening retarder, and 2 parts by mass of ferric oxide (Fe₃O₄). To 100 parts by mass of the resulting mixture is added 5 parts by mass of glycidoxypropyltrimethoxysilane. The mixture with glycidoxypropyltrimethoxysilane is diluted to 40% by mass with n-heptane to obtain an adhesive composition.

### Fabrication of Fixing Roller

The adhesive composition is applied to a thickness of 10 μm on the elastic layer. A PFA tube is attracted to the inner surface of a cylindrical mold under reduced pressure. The elastic layer coated with the adhesive composition is then inserted into the mold. After the insertion is complete, the reduced pressure is removed to cover the elastic layer with the PFA tube. A fixing roller is thus obtained.

The elastic layer of the fixing roller is determined to have been irradiated with UV radiation from the presence of hydroxyl groups by spectroscopy using an infrared spectrometer (Smiths Detection). The content of the glycidoxy-containing silane coupling agent in the adhesive layer of the fixing roller is measured by extracting the silane coupling agent using a gas chromatograph/mass spectrometer (GC-MS) (GC-2010, Shimadzu Corporation).

### Measurement and Evaluation

The thus-fabricated fixing roller is mounted on an image-forming apparatus (DocuCentre-III C3300 color copier, Fuji Xerox Co., Ltd.) and is tested by printing 150,000 copies. After testing, a sample of a magenta halftone with an image density of 50% is taken and visually inspected for image quality according to the following criteria. The results are shown in Table 1.

### Image Quality Criteria

A: There are no color spots due to separation between the elastic layer and the adhesive layer.

B: There are very slight color spots due to separation between the elastic layer and the adhesive layer (practicable).

C: There are slight color spots due to separation between the elastic layer and the adhesive layer (impracticable in some cases).

D: There are color spots due to separation between the elastic layer and the adhesive layer (impracticable).

### Examples 2 to 6

Fixing rollers are fabricated as in Example 1 except that the glycidoxy-containing silane coupling agent (glycidoxypropyltrimethoxysilane) is added to the adhesive composition in the amounts shown in Table 1. The resulting fixing rollers are evaluated as in Example 1.

### Comparative Example 1

A fixing roller is fabricated as in Example 1 except that no glycidoxy-containing silane coupling agent is added to the adhesive composition and the surface of the elastic layer is not irradiated with UV radiation. The resulting fixing roller is evaluated as in Example 1.

### Comparative Example 2

A fixing roller is fabricated as in Example 2 except that the surface of the elastic layer is not irradiated with UV radiation. The resulting fixing roller is evaluated as in Example 1.

### Comparative Example 3

A fixing roller is fabricated as in Example 1 except that no glycidoxy-containing silane coupling agent is added to the adhesive composition. The resulting fixing roller is evaluated as in Example 1.

### Reference Example

A fixing roller is fabricated as in Example 1 except that the glycidoxy-containing silane coupling agent is added to the adhesive composition in an amount of 50% by mass. The resulting fixing roller is evaluated as in Example 1.

TABLE 1

| | Content of silane | | |
|---|---|---|---|
| | coupling agent (mass %) | UV irradiation | Color spots |
| Example 1 | 5 | Irradiated | A |
| Example 2 | 10 | Irradiated | A |
| Example 3 | 20 | Irradiated | A |
| Example 4 | 30 | Irradiated | B |
| Example 5 | 3 | Irradiated | C |
| Example 6 | 35 | Irradiated | C |
| Comparative | — | Not irradiated | D |
| Example 1 | | | |
| Comparative | 10 | Not irradiated | D |
| Example 2 | | | |
| Comparative | — | Irradiated | D |
| Example 3 | | | |
| Reference | 50 | Irradiated | Not applicable |
| example | | | due to gelling |

The fixing rollers of the Examples may be more resistant to separation between the elastic layer and the adhesive layer than the fixing roller of Comparative Example 3, which includes an adhesive layer containing no glycidoxy-containing silane coupling agent.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing member comprising:
a substantially cylindrical substrate;
an elastic layer disposed around the substrate, the elastic layer having a surface irradiated with UV radiation;
a surface layer covering the surface of the elastic layer; and
an adhesive layer disposed between the elastic layer and the surface layer, the adhesive layer comprising a glycidoxy-containing silane coupling agent.

2. The fixing member according to claim 1, wherein the glycidoxy-containing silane coupling agent is present in the adhesive layer in an amount of about 5% to about 30% by mass of the total mass of the adhesive layer.

3. A fixing device comprising the fixing member according to claim 1.

4. An image-forming apparatus comprising:
an image carrier having a surface;
a charging unit that charges the surface of the image carrier;
a latent-image forming unit that forms an electrostatic latent image on the surface of the image carrier;
a developing unit that develops the electrostatic latent image formed on the surface of the image carrier with a toner to form a toner image;
a transfer unit that transfers the toner image to a transfer medium; and
the fixing device according to claim 3, the fixing device fixing the toner image to the transfer medium.
